(19) United States
(12) Patent Application Publication
(10) Pub. No.: US 2008/0008164 A1
(43) Pub. Date: Jan. 10, 2008

(54) Network wireless telephone and method for using such wireless telephone in a network

(76) Inventor: Jorg Wacker, Darmstadt (DE)

Correspondence Address: SHERIDAN ROSS PC, 1560 BROADWAY, SUITE 1200, DENVER, CO, 80202, US

(21) Appl. No.: 11/229,354

(22) Filed: Sep. 16, 2005

(30) Foreign Application Priority Data
Sep. 18, 2004 (DE) 10 2004 045 449.3

(51) Int. Cl. H04L 12/66

(52) U.S. Cl. 370/356

(57) ABSTRACT

In an Internet telephone network, a radio access point is provided, the network interface in a telephone terminal is designed as a radio interface and the telephone terminal is a system telephone with special functions, carried out based on a telephone system protocol, in which the radio interface of the telephone terminal transmits the special functions with the speech data in tunneled fashion.

The invention concerns a method for operation of a telephone terminal in the network, in which the telephone terminal has a network interface, which digitizes speech signals bidirectionally and packages them based on the Internet protocol, as well as a corresponding telephone terminal and a network, in which such a telephone terminal can be operated.

After first attempts in the nineteen nineties, Internet telephony is on the point of acquiring increasingly greater market share in the operation of telecommunications. Whereas previous Internet telephone offers are of low level with respect to speech quality, nowadays, thanks to broadband Internet access and well designed networks, Internet telephony can ensure adequate speech quality. Relative to ordinary telephone communications, use of the telephone with Internet telephony can be accomplished much more cheaply, because of convergence of the networks for speech and data transmission.

In Internet telephony, the speech signals are compressed and digitized and transmitted in the form of speech packets, using an Internet protocol, to the conversion partner via a communications network. The H.323 standard is generally used as Internet protocol for speech transmission. Telephone terminals in Internet telephony can be both computers with a network card, having a loudspeaker and a microphone, as well as regular telephones that are equipped with a corresponding Internet protocol-capable network card. The network card of the Internet card, as in the computers, is then connected via a network cable to a fixed network jack.

In Internet telephony, the network card in the Internet telephone or Internet telephone-capable computer converts the speech signals, according to the H.323 standard access protocol, to compressed digital signals and packages the compressed digital speech data to speech packets for transmission in the network. An Internet communications server connected to the network then controls the connection process. The IP communications server is generally a gateway that converts the Internet addresses to telephone numbers and vice versa, assumes access control with allowance for network utilization and manages network bandwidth.

A shortcoming in known Internet telephone terminals, as used, in particular, in the business field, is lack of flexibility. During rearrangement of workplaces in a company, it is generally necessary to connect the Internet telephone terminals with new cables to the company network, in order to use Internet telephony. In addition, the usual Internet telephone terminals also have only limited performance and use comfort, since the H.323 standard permits only few performance features.

The objective of the invention is to provide a method for operation of a telephone terminal in a network, a corresponding network and a corresponding telephone terminal, which are characterized by high flexibility and considerable operating comfort.

This task is solved with a method according to Claim 1, a network according to Claim 3 and a telephone terminal according to Claim 5. Preferred modifications are mentioned in the dependent claims.

According to the invention, to accomplish Internet telephony, the network is provided with a radio access point, the network interface in the telephone terminal is designed as a radio interface and the telephone terminal is a system telephone with special functions that are executed based on a telephone system protocol, in which the radio interface of the telephone terminal transmits the special functions in tunneled fashion with the speech data.

With the layout of Internet telephony according to the invention, in which the Internet telephone has high performance and operating comfort as a system telephone and is laid out portable, because of its connection to the network via a radio link, the possibility exists of being able to use Internet telephony in highly flexible fashion, especially in the business field. With the portable Internet system telephones according to the invention, new workplaces can be setup simply and cost-effectively in rapidly growing companies without additional cabling expense. The Internet system telephones according to the invention also offer considerable performance and operating scope, which permits qualitatively high-value telephoning even over the Internet. The performance features of the system telephone, which are based on a telephone system protocol, are then transmitted with the speech data in tunneled fashion together to the conversation partner.

It is preferred to use, as radio standard for transmission of the speech data with the tunneled special functions, the WLAN standard 802.11. Because of this, it is possible to resort to existing WLAN infrastructure in Internet telephony, and also use already available WLAN data terminals and WLAN mobile telephones in the context of Internet telephony.

According to another preferred variant, the radio interface in the telephone terminal is laid out pluggable. Because of this, there is a possibility of using existing system telephones, for example, ISDN system telephones, in the context of Internet telephony, by simple retrofitting.

It is also preferred that the special functions of the Internet system telephone are ISDN performance features. Because of this maximum operating comfort is achieved for the user of the Internet telephone, since the user then finds all the known functions from regular connection-oriented telephony even in Internet telephony.

The invention is explained further by means of the accompanying drawings. In the drawings:

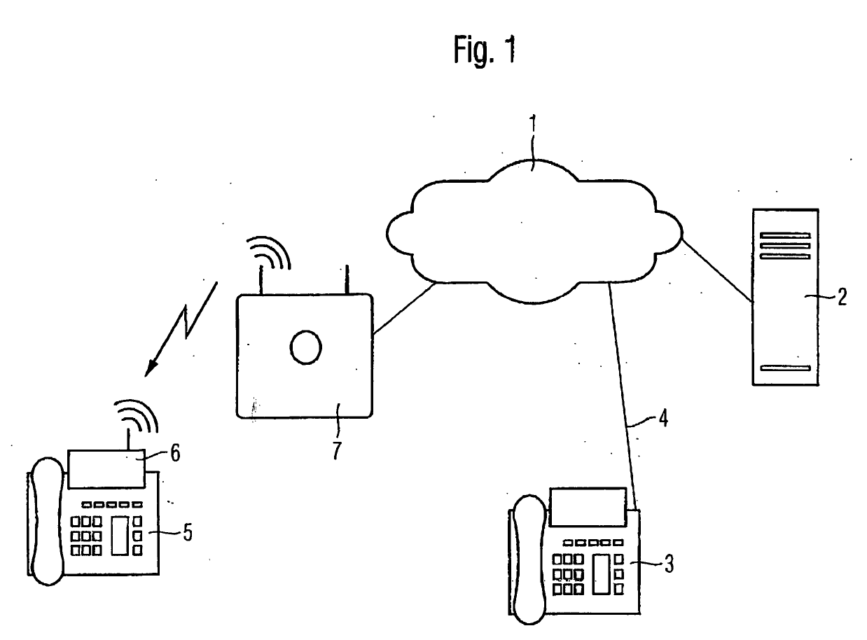

FIG. 1 shows a network according to the invention for Internet telephony; and

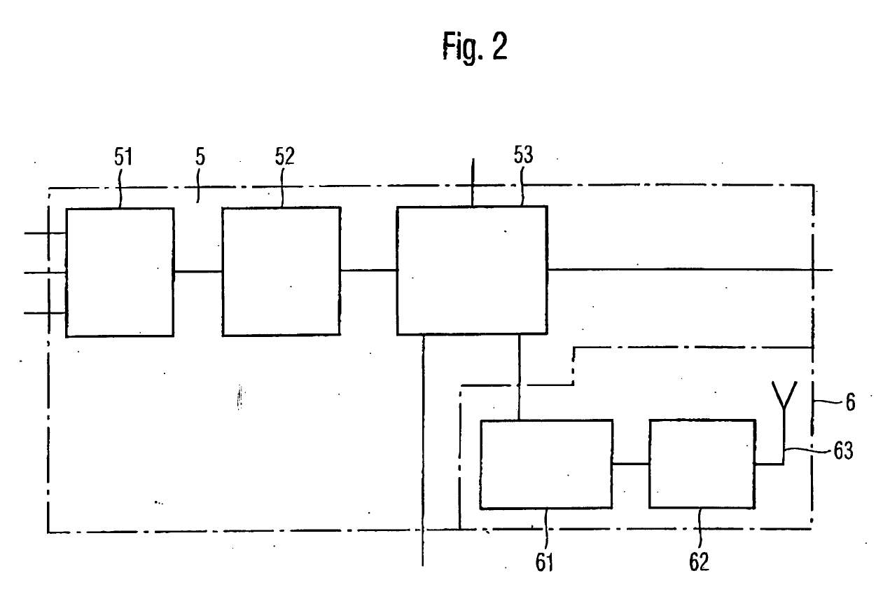

FIG. 2 shows a block diagram of an interface of an Internet system telephone according to the invention.

In addition to telephony via power-supplying networks, in which an almost fixed line is made available between the conversation partners for the duration of the connection, packet-oriented communication systems are increasingly being setup, because of the cost advantages. Thanks to broadband Internet access and well-constructed networks of the Internet providers, Internet telephony is increasing in importance.

In Internet telephony, the speech signals received via a microphone are converted to a digital data stream by means of an analog-digital converter. The data then are generally compressed and then packaged in speech data packets. These are then transmitted over a network to the desired conversation partner, using an Internet access protocol, generally the H.323 protocol, which permits real-time data transmission of audio and video data via networks. The incoming data packets are then combined to a digital data stream at the conversation partners, decompressed and converted back to an analog speech signal by means of a digital-analog converter.

Computers with a network card and headset or loudspeaker and microphone can be used as telephone terminals for Internet telephony. However, analog telephones equipped with a corresponding network card for conversion of speech signals to digital data packets can also be used. Such Internet telephony-capable terminals are ordinarily connected to a fixed network jack via network cables. Computers used for Internet telephony and ordinary Internet telephones, because of their fixed connection to the network, have only restricted flexibility, which can be of particular interference in the field of business communication. In addition, ordinary Internet telephones only have restricted performance and operating comfort, since the standard access protocol H.323 offers only few basic telephone performance features. New performance features must be implemented by means of considerable software expense.

The present invention ensures increased flexibility in Internet telephony, especially during use in business communications and for improved performance and operating comfort. According to the invention, the Internet telephony network has a radio access point, whereas the corresponding telephone terminal has a radio interface as network card. This telephone terminal is also laid out as a system telephone with special functions that are designed based on a telephone system protocol, for example, the ISDN protocol. The interface of the telephone terminal ensures that these special functions are transmitted in tunneled fashion with the speech data packets to the conversation partner. With this layout, it is possible to setup new workplaces without additional cabling expense with the portability of the Internet telephone terminals, achieved by radio connection. In addition, dynamic workgroups can be formed quickly and without problem in discussions or conferences or fairs by means of portable Internet telephone terminals. By tunneling of the special functions managed based on telephone system protocols, especially the ISDN protocol, the performance for telephone services known according to the ISDN standard principle can also be guaranteed in Internet telephony from line-oriented telephony. This performance and operating comfort can then also be utilized in company areas by portable layout of the Internet telephones, which previously have only been connected with restrictions to the Internet.

FIG. 1 shows an Internet telephony network 1 according to the invention. The network 1 can be any packet-oriented communications system that operates according to the Internet protocol. At least one Internet communications server 2, which controls the connection processes between Internet telephone subscribers, is connected to the network 1, which is laid out as a wide area network (WAN) or local area network (LAN). The task of the IP communication server 2 is conversion of Internet addresses to telephone numbers and vice versa, access control, with allowance for network utilization for management of the network bandwidth. Two telephones are connected as terminals to the depicted network, in which one telephone is an ordinary Internet-capable telephone 3, having a network card, which is connected rigidly to the network via a network cable 4.

The second connected telephone is an Internet system telephone 5, modified according to the invention, which has a radio interface 6 as network card, as further shown in FIG. 2. This interface 6 transmits data between the Internet system telephone and an access point 7, a so-called wireless access point, which is connected to the network. Data transmission then preferably occurs according to the so-called IEEE 802.11 radio standard, in which radio waves, generally in the 2.4 GHz band range are used for data transmission. However, there is the possibility of using a different radio standard, for example, the hyper LAN standard, for transmission of radio data between the network card of Internet system telephone 5 and the access point 7. According to the invention, for connection of the portable Internet system telephone 5 to the network 1, an already existing wireless LAN infrastructure can therefore be utilized. The portable Internet system telephone is therefore ideally supplemented with an already available WLAN data terminal and WLAN mobile telephones.

These WLAN mobile telephones, in contrast to the Internet system telephone 5 according to the invention, however, have only a very limited performance and operating comfort, since access is possible with the access point exclusively with the performance features that are available from the H.323 access protocol. Additional performance features can be implemented in WLAN mobile telephones only with significant software costs by protocol expansion. With the portable Internet system telephone according to the invention, in contrast to this, the complete performance range of ordinary line-oriented telephony, as is known from the ISDN area, can be made available. This is achieved by the fact that with the portable Internet system according to the invention, the performance features that are designed with a telephone system protocol, for example, the ISDN protocol, are transmitted in tunneled fashion to the conversation partner with the Internet speech data packets.

The radio interface 6 of the portable Internet system telephone 5 according to the invention, which is shown in FIG. 2 in block diagram, has a speech digitization unit 51 [German text lists 61 but should be 51 according to “List of Reference Numbers”] for this purpose, a so-called Codec unit, which is connected to the speech hardware of the telephone, the loudspeaker, the microphone or the headset (lines are indicated). The Codec unit 61 compresses and decompresses the electrical speech signals exchanged with the hardware, in which sufficient speech quality is simultaneously guaranteed.

A digital signal processor 62 is connected to the Codec unit 61, which digitizes the speck signals compressed by the Codec unit 61. The digital signal process 62 is also connected to the interface main processor 63, which converts the digitized data signals according to the Internet protocol running on the communications network to data packets. The data packets are then additionally provided with address information.

The main processor 63 is also connected to the input and output units of the telephone, the display, the keyboard and the functional memory (lines are indicated), in order to transmit additional performance features of the Internet system telephone in tunneled fashion via the data packets. These performance features are faded in and out of sections of the data packets prescribed for this by processor 63. Because of this, it is possible to utilize, for example, the complete ISDN performance features in Internet telephony, like further connection, call forwarding, call holding, messages, names, call back, etc., in Internet telephony. The processor 63 is also connected to a radio unit, which has a radio conversion unit 64 that converts the data packets into the desired frequency band, for example, the standard WLAN frequency at 2.4 GHz, and then transmits then to a transmitter unit 65, which carries out data exchange with the access point 7 of network 1 via an antenna 66.

A telephone conversation, in the context of Internet telephony, with the communications network according to the invention is laid out, so that the conversation participants using the portable Internet system telephone 6 according to the invention enter the desired telephone number of the conversation participant via the keyboard and determine additional performance features of the telephone conversation. At the same time, according to the H.323 access protocol, a corresponding conversation notification is carried out via the Internet communication server 2 and the desired conversation participant is accessed. The two conversation participants can then speak with each other.

In the Internet system telephone, the speeches converted by the microphone to electrical speech signals, then compressed by the Codec unit 61 and by the digital signal processor 62 are converted to a digital data stream. This digital data stream is then packaged by the main processor 63 into Internet data packets, in which the desired telephone performance features are faded into the sites prescribed for them in the data packets. The data packets are then converted to the corresponding radio band via the radio conversion unit 64 and emitted by the transmitter 65 to the access point 7 via antenna 66. The radio signals are then converted at access point 7 back into electrical data signals and transmitted to the Internet telephone of the conversation participant, for example, telephone 3, by means of the Internet communication server 2 via network 1. Here, the data packets are then combined back into a digital data stream and converted back to an analog speech signal, in order to be emitted via the telephone loudspeaker.

With the Internet telephony layout according to the invention, it is possible to use telephones flexibly with high functionality and operating comfort via the Internet. It is decisive here that the Internet system telephone according to the invention is laid out portable, so that it can be used flexibly. The radio interface on the Internet system telephone can then also be designed as a retrofittable module. The access point on the network ensures reliable radio data exchange. By tunneling of the performance features during speech data transmission in the form of Internet data packets, high operating comfort and a large range of performance are also ensured.

### LIST OF REFERENCE NUMBERS

1 Network
2 Internet communication server
3 Internet-capable telephone
4 Network cable
5 Internet system telephone
6 Radio interface
7 Radio access point
51 Speech digitization unit
61 Codec unit
62 Signal process
63 Interface main processor
64 Radio conversion unit
65 Transmitter
66 Antenna

1. Method for operation of a telephone terminal (5) in a network (1), in which the telephone terminal has a network interface (6), which digitizes speech signals bidirectionally and packages them based on the Internet protocol into speech packets,
characterized by the fact
that the network has a radio access point (7), that the network interface (6) of the telephone terminal is a radio interface,
and that the telephone terminal (5) is a system telephone with special functions, laid out based on a telephone system protocol,
in which the radio interface (6) of the telephone terminal transmits the special functions in tunneled fashion with the speech data packets.

2. Method according to claim 1, characterized by the fact that the WLAN standard 802.11 is used as radio standard.

3. Network (2) with at least one telephone terminal (5), which has a network interface (6), which digitizes speech signals bidirectionally and packages them, based on the Internet protocol, into speech packets,
characterized by the fact
that the network (1) has a radio access point (7), that the network interface (6) of the telephone terminal (5) is at radio interface, and
that the telephone terminal (5) is a system telephone with special functions, laid out based on a telephone system protocol,
in which the radio interface (6) of the telephone terminal is laid out to transmit the special functions in tunneled fashion with the speech data packet.

4. Network according to claim 3, characterized by the fact that the WLAN standard 802.11 is used as radio standard.

5. Telephone terminal (5) for operation in network (1) with a network interface (6), that digitizes speech signals bidirectionally and packages them based on the Internet protocol into speech packets,
characterized by the fact
that the network interface (6) and the telephone terminal (5) is a radio interface, laid out for radio transmission of the speech packets to a radio access point (7) in network (1), and
that the telephone terminal (5) is a system telephone with special functions, laid out based on the telephone system protocol,
in which the radio interface (6) of the telephone terminal is laid out to transmit the special functions in tunneled fashion with the speech data packets.

6. Telephone terminal according to claim 5, characterized by the fact that the radio interface (6) is laid out pluggable.

7. Telephone terminal according to claim 5 or 6, characterized by the fact that the special function are ISDN performance features.
